(19) United States
(12) Patent Application Publication
(10) Pub. No.: US 2020/0120371 A1
(43) Pub. Date: Apr. 16, 2020

(54) SYSTEMS AND METHODS FOR PROVIDING AR/VR CONTENT BASED ON VEHICLE CONDITIONS

(71) Applicant: Rovi Guides, Inc., San Jose, CA (US)

(72) Inventors: Susanto Sen, Bangalore (IN); Vikram Makam Gupta, Bangalore (IN)

(21) Appl. No.: 16/156,860

(22) Filed: Oct. 10, 2018

(51) Int. Cl. H04N 21/2343; H04N 21/414; H04N 21/81; H04N 21/258; H04N 21/234

(52) U.S. Cl. CPC H04N 21/23439; H04N 21/41422; H04N 21/23424; H04N 21/25841; H04N 21/25891; H04N 21/816

(57) ABSTRACT

A user may view a media asset such as augment reality content or virtual reality content while traveling in a vehicle. Data from vehicle systems may be used to identify a vehicle motion profile for the vehicle. This vehicle motion profile may be compared to scene motion profiles for scenes of media assets to identify scenes that correspond to the motion of the vehicle. The selected scenes may be delivered to the user for viewing to correspond with appropriate travel conditions for the vehicle.

### BACKGROUND

The present disclosure is directed to systems for providing media assets to a user, and more particularly, to systems that provide media assets based on vehicle conditions.

### SUMMARY

Passengers in vehicles such as automobiles may wish to view a media asset during the journey of the vehicle. Augmented reality and virtual reality technologies have developed that enable viewers to enjoy an immersive viewing experience. For augmented reality (AR) the immersive content may be superimposed upon the real-world environment, and in some systems and applications may be related to the real-world environment. For virtual reality (VR) the immersive content may occupy most or all of the user's field of view. AR/VR systems may also include other output sources such as audio and haptic outputs. AR/VR systems may be responsive to the user's movements such as head and hand movements. Failure of an AR/VR system to respond immediately to the user's movements may provide a diminished user experience, and may even induce disorientation or nausea in the user. These effects may be exacerbated by external conditions such as the movement of the vehicle.

In some embodiments of the present disclosure, a device such as a AR/VR device may be provided for presenting a scene of a media asset for display in a vehicle. The vehicle may include a variety of systems that collect information about the vehicle. Vehicle status data may be provided based on the collected vehicle data, and a vehicle motion profile may be identified based on the vehicle status data. Scenes from media assets may be provided for display on the AR/VR device based on the vehicle motion profile. Respective scenes of media assets may have scene motion profiles that have data that represents a type of motion depicted in a portion of the media asset. The vehicle motion profile may be compared to the scene motion profiles to select an appropriate scene to be displayed at the AR/VR device.

Similarity scores may be calculated for the vehicle motion profile in comparison to the scene motion profiles. The scene that is selected for display at the AR/VR device may be based on the similarity scores, for example, by identifying a subset of scenes that have similarity scores that exceed a similarity value. The scene for display to the user from the subset of scenes may then additionally be selected based on information in a user profile, such as preferred genres, preferred media assets, or preferred actors. A variety of other information may also be used to select scenes for display, such as environmental conditions or locale information.

The vehicle status data that is acquired from the vehicle may represent a variety of types of information, such as velocity, acceleration, change in altitude, direction, or angular velocity. This and other vehicle status data may be used to determine vehicle motion profiles for current and predicted motion, such as whether the vehicle is or will be turning, rising, falling, accelerating, or decelerating. The AR/VR device may provide additional outputs such as haptic outputs and audio. In some embodiments, those additional outputs may be controlled based on information from the vehicle, such as the vehicle status data or vehicle motion profile.

In some embodiments, a predicted set of motion profiles may be determined, for example, based on the vehicle status data and location data for the vehicle. This information may be used to identify predicted future travel for the vehicle, and based on the predicted future travel, additional vehicle motion profiles may be identified. These additional vehicle motion profiles may be compared with scene motion profiles to select scenes to be provided to the AR/VR device. These predicted sets of motion profiles may be updated continuously or periodically, for example, based on changed vehicle status data or changes in predicted future travel.

A media asset may be modified, based on the vehicle motion profile, for example, by inserting appropriate content into the media asset that corresponds to the vehicle motion profile. For example, the media asset may include particular points within the media asset where it is appropriate to insert content, such as during transitions between scenes, locations, or dialogue. An insertion point may be identified and the scene that corresponds to the vehicle motion profile may be played at the insertion point.

### BRIEF DESCRIPTION OF THE DRAWINGS

The below and other objects and advantages of the disclosure will be apparent upon consideration of the following detailed description, taken in conjunction with the accompanying drawings, in which like reference characters refer to like parts throughout, and in which:

FIG. 1 shows an illustrative embodiment of a user experiencing a media asset in a vehicle under a first set of vehicle conditions, in accordance with some embodiments of the disclosure;

FIG. 2 shows an illustrative embodiment of a user experiencing a media asset in a vehicle under a second set of vehicle conditions, in accordance with some embodiments of the disclosure;

FIG. 3 shows an illustrative embodiment of a user experiencing a media asset in a vehicle under a third set of vehicle conditions, in accordance with some embodiments of the disclosure;

FIG. 4 is a block diagram of an illustrative user equipment (UE) device, in accordance with some embodiments of the disclosure;

FIG. 5 is a block diagram of an illustrative media system, in accordance with some embodiments of the disclosure;

FIG. 6 is a flowchart of a process for providing a scene of a media asset based on vehicle conditions, in accordance with some embodiments of the disclosure;

FIG. 7 is a flowchart of a process for creating a composite media asset based on vehicle conditions, in accordance with some embodiments of the disclosure; and

FIG. 8 is a flowchart of a process for analyzing media assets for motion profiles in accordance with some embodiments of the present disclosure.

### DETAILED DESCRIPTION

The present disclosure is related to the selection and display of portions of a media asset on a user equipment device of a user in a vehicle. An exemplary user equipment device may be capable of displaying a variety of content types, such as standard video content, augmented reality content, or virtual reality content. The user equipment may include a display (e.g., an immersive display) and in some embodiments may include a variety of other outputs that provide information to a user, such as a variety of audio and haptic outputs. The user equipment may respond to movements of a user, such as head movements, eye movements, hand motions, other suitable user movements, and patterns of any such movements. The response may modify the display of the media asset, such as by displaying a different portion or view of the media asset, providing interactive content with the media asset, or modifying display options of the media asset.

Automobiles have a variety of systems that capture information about virtually all aspects of vehicle operation, and increasingly, exterior and environmental conditions. For example, automotive sensors may collect information about velocity, acceleration, angular velocity, altitude, roll, internal temperature, external temperature, braking, humidity, rain, snow, fog, cloud cover, wind, light, adjacent items or structures, etc. Such systems are used to measure certain parameters directly, and in many instances, can be combined to calculate a variety of other parameters. Patterns may be discerned from these measured and calculated, such as driver acceleration and braking patterns, weather patterns, and traffic patterns. Any such information (e.g., measured, calculated, or pattern data) may correspond to vehicle status data.

The vehicle status data may be analyzed to determine a vehicle motion profile by computing systems of the vehicle, electronics modules of the vehicle, the user equipment, other computing devices in the vehicle, or any suitable combination thereof. In some embodiments, additional information from other sources such as the user equipment or a network connection (e.g., a wireless network connection of a vehicle or user equipment) may also be used to determine the vehicle motion profile. For example, location information, traffic information, weather information, navigation routes, and other relevant information may be provided via a network connection. Based on the vehicle status data, additional information, or both, one or more vehicle motion profiles may be determined. A vehicle motion profile may correspond to categories of motion that may be experienced virtually through a media asset, such as turning, rising, falling, accelerating, or decelerating. In some embodiments, multiple vehicle motion profiles may be determined for a trip, for example, based on a route being navigated or a predicted route. The multiple vehicle profiles may be combined into a composite vehicle profile that may be used to preemptively select scenes from media assets. The composite vehicle motion profile may be updated based on changes in the vehicle status data, route, other additional information, or a suitable combination thereof.

A vehicle motion profile may be compared to data related to media assets to identify scenes that correspond to the vehicle motion profile. A scene of a media asset may refer to any discernable portion of the media asset that includes a particular motion profile, including short clips and ranging to lengthier storylines such as a car chase, aerial stunts, or a mountain climb. For example, a media asset may be analyzed to identify different portions of the media that include certain types of motion, and this information may be combined with other information from the media asset (e.g., metadata describing the media asset) to identify scenes for purposes of establishing scene motion profiles. In some embodiments, the available scenes for comparison to the vehicle motion profile may be based on the media asset or user information, such as a user profile that includes a set of preferences or a genre of the media asset. In some embodiments a third-party provider of the media asset may provide a selection of scenes for insertion into a media asset, for example, as advertisements.

The comparison of the vehicle motion profile to the scene motion profiles may be performed in a variety of manners, for example, by determining a similarity score between the vehicle motion profile and each of the available scene motion profiles. In the instance of a composite vehicle motion profile it may be desirable to identify a scene motion profile that includes a similar composite series of motion profiles. In some embodiments, a subset of scenes may be identified from the similarity scores, and user profile information, media asset information, or a combination thereof may be used to select a scene or scenes for display.

The selected scene or scenes may be provided for display at the user equipment. In an exemplary embodiment, when a particular vehicle motion profile is identified a scene that corresponds to the profile may be played. If a media asset is playing, the playing of the media asset may be interrupted. In some embodiments, a notification that a scene related to vehicle motion is available may be provided to the user, and the scene may be played based on the user's response. In the exemplary case of advertisements, the playing of a media asset may be interrupted in order to provide an advertisement that will be more memorable due to the correspondence to vehicle motion. In some embodiments, media assets may be designed with different story paths that may be available based on different vehicle motion during a trip. In additional embodiments, a composite media asset may be created from similar or related media assets to correspond to a trip. The scenes that correspond to vehicle motion may then be displayed in any suitable manner, such as in a traditional video or audio format or as augmented reality or virtual reality content.

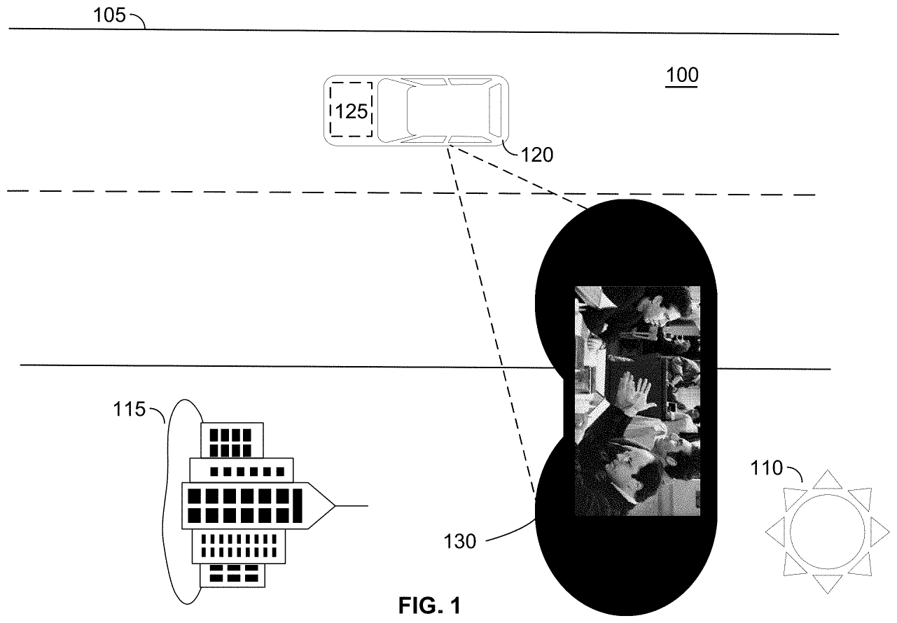

FIG. 1 shows an illustrative embodiment of a user experiencing a media asset in a vehicle under a first set of vehicle conditions, in accordance with some embodiments of the disclosure. As depicted in FIG. 1, a travel environment 100 may include a vehicle such as an automobile 120 traveling on a travel path such as roadway 105. Although the embodiments described herein may be discussed in the context of an automobile traveling on a roadway, it will be understood the present disclosure may apply to any suitable vehicle (e.g., car, motorcycle, scooter, cart, truck, bus, boat, train, street car, subway, airplane, personal aircraft, drone, etc.) traveling along any suitable travel path (e.g., roadway, path, waterway, flight path, etc.).

The travel environment 100 may also include environmental conditions 110 and locale information 115. Environmental conditions 110 may include conditions external to the vehicle such as current weather conditions (e.g., temperature, precipitation, pressure, fog, cloud cover, wind, sunlight, etc.) and locale information 115 may include information about a locale such as the presence of buildings, other vehicles, topography, waterways, trees, other plant life, pedestrians, animals, businesses, and a variety of other information that may be identified or observed from a vehicle (e.g., via systems of a vehicle) or provided to the vehicle or a user equipment device in a vehicle, (e.g., via intra-vehicle communications or local communication networks). In the exemplary embodiment of FIG. 1, the environmental conditions may include dry and sunny conditions and the locale may be a dense urban environment, such as the Upper West Side of New York, N.Y.

The vehicle 120 may include vehicle systems 125 that enable the acquisition and analysis of vehicle status data based on the operation of vehicle 120, environmental conditions 110, \locale conditions 115, or other information sources. Vehicle systems will depend on the vehicle type, and in the case of an exemplary automobile may include numerous sensors such proximity sensors, ultrasonic sensors, radar, lidar, temperature sensors, accelerometers, gyroscopes, pressure sensors, humidity sensors, and numerous other sensors. Internal systems of vehicle 120 may monitor vehicle operations, such as navigation, powertrain, braking, battery, generator, climate control, and other vehicle systems. The vehicle systems 125 may also include communication systems for exchanging information with external devices, networks, and systems, such as cellular, WiFi, satellite, vehicle-to-vehicle systems, infrastructure communication systems, and other communications technologies. These vehicle systems 125 may acquire numerous data points per second, and from this data may identify or calculate numerous types of vehicle status data, such as location, navigation, environmental conditions, velocity, acceleration, change in altitude, direction, and angular velocity. In some embodiments, vehicle systems may also utilize this vehicle status data to generate a vehicle motion profile, which may correspond to categories of motion of a vehicle that may be experienced virtually through a media asset, such as turning, rising, falling, accelerating, or decelerating. In the exemplary embodiment of FIG. 1, analysis of vehicle status data such as velocity, acceleration, angular velocity, and external traffic data may indicate relatively low speed travel with few jarring accelerations or decelerations.

A passenger in the vehicle 120 may have a user equipment device 130 displaying a media asset. Although a user equipment device 130 may be any suitable device as described herein, in an exemplary embodiment the user equipment device may be a virtual reality device that provides an immersive presentation of a media asset. The user equipment device 130 may be in communication with the vehicle systems 125 via a direct connection (e.g., via WiFi, Bluetooth, or other communication protocols) or indirectly via a network (e.g., such as a cellular network, internet protocol network, satellite, or other wireless communication network). The user equipment may also include sensors and systems for determining information about the user and the vehicle, such as inertial and other sensors of the user equipment device 130 or another device associated with a user (e.g., a smart phone or smart wearable device). The user equipment 130 may also acquire information from other sources, such as over another network as described herein. This information may include user profile information that may include user preferences about media asset playback as described herein, media asset query and delivery systems, and other related systems for searching, analyzing, and delivering media assets to a user.

The user equipment 130 may receive vehicle status data, vehicle motion profiles, or any suitable combination thereof. In some embodiments, user equipment 130 may combine this with other data acquired by the user equipment 130 as described herein, such as environmental conditions, locale information, a user profile, and media guidance information. This information may be collectively analyzed as described herein based on a comparison to scene motion profiles of media assets or portions thereof. In the exemplary embodiment of FIG. 1, a portion of an episode “Seinfeld” may be displayed as the media asset at the user equipment, which may correspond to the relatively stable and uniform motion of the vehicle, as well as user preference and locale information.

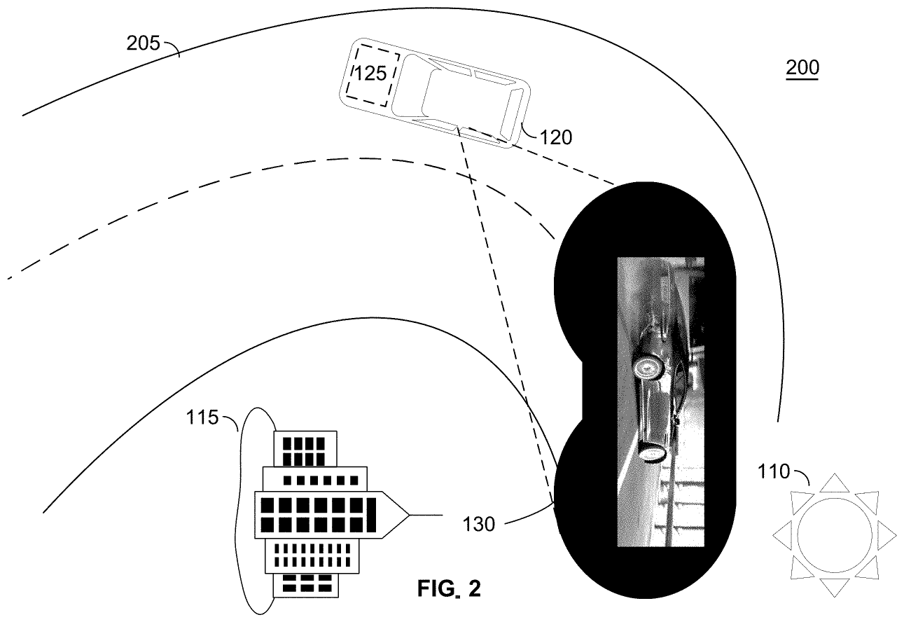

FIG. 2 shows an illustrative embodiment of a user experiencing a media asset in a vehicle under a second set of vehicle conditions, in accordance with some embodiments of the disclosure. As depicted in FIG. 2, certain aspects of travel environment 200, such as environmental conditions 110 and locale information 115, may be substantially similar to those depicted in FIG. 1. However, the roadway 205 and the operation of the vehicle 120 as monitored by vehicle systems 125 and/or user equipment device 130 may be substantially different from those experienced in the exemplary embodiment of FIG. 1. For example, in the exemplary embodiment of FIG. 2, the roadway 205 may have a large number of turns or curves during traffic patterns that result in relatively abrupt inertial forces that are felt by the vehicle 120 and a passenger therein viewing a media asset on user equipment 130. Based on the collected information as described herein, vehicle status data may be collected, a vehicle motion profile may be determined, and the vehicle motion profile and other information as described herein may be compared to scene motion profiles associated with candidate media assets. In the exemplary embodiment depicted in FIG. 2, a car chase scene in an urban environment may be displayed as a media asset by user equipment device 130.

The media asset that is displayed may be generated as a composite media asset based on vehicle motion profiles that are experienced during a trip, predicted vehicle motion profiles for the trip, or both. A primary media asset may be interrupted based on changes in the vehicle motion profile and the primary media asset. For example, commercial breaks may be inserted that correspond to the vehicle motion profile and are related to the primary media asset (e.g., based on metadata of media assets such as characters, actors, genres, subject matter, location, depicted time period, and other similar information about the media asset). In some embodiments, composite media assets may be generated or created based on the changes in vehicle motion characteristics for a trip. A composite media asset may be generated from distinct media assets, or in some embodiments, custom composite media assets may be created that provide for different “stories” based on changes in vehicle motion profiles and other information (e.g., environment, locale, user selections, etc.) as described herein. In some embodiments, a user may select a grouping of media assets for viewing based on the vehicle motion profile and other relevant information. For example, a user may have currently selected a set of media assets that are in a watchlist of media assets to selectively display to the user by the user equipment device 130. Progress in viewing a particular media asset may be paused at an appropriate point (e.g., a transition between scenes, dialog, actors, or locations within a media asset) and stored when the vehicle motion profile or other information changes such that display of a scene from another media asset is desirable.

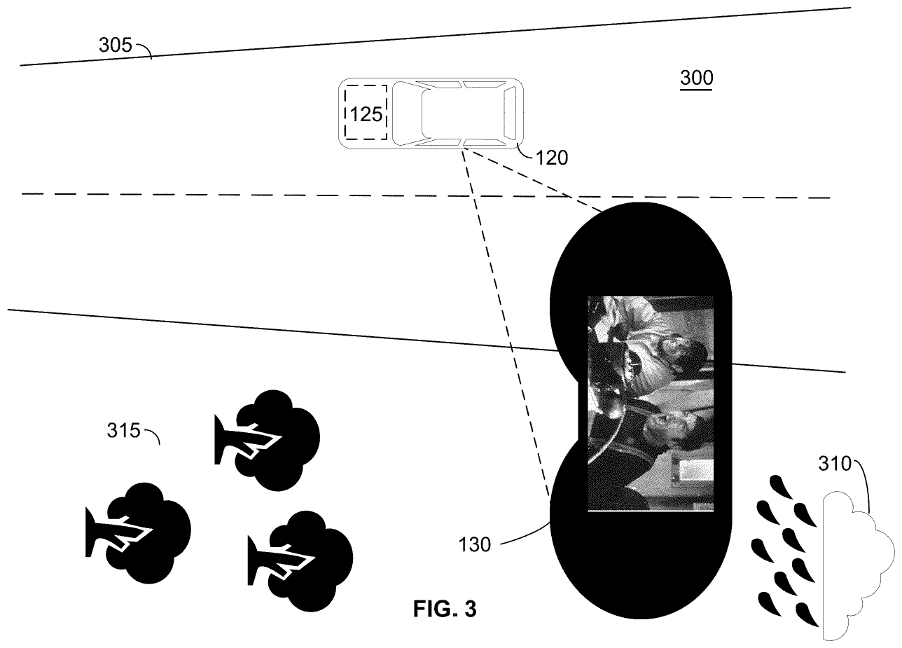

FIG. 3 shows an illustrative embodiment of a user experiencing a media asset in a vehicle under a third set of vehicle conditions, in accordance with some embodiments of the present disclosure. As depicted in FIG. 3, certain aspects of travel environment 300 may be substantially different from those depicted in FIGS. 1-2. For example, the roadway 305 may be on a downhill grade, the environmental conditions 310 may include heavy rain, and the locale 315 may be a rural environment. Accordingly, the parameters of the operation of the vehicle 120 as monitored by vehicle systems 125 and/or user equipment device 130 may be substantially different from those experienced in the exemplary embodiments of FIGS. 1-2. Based on the collected information as described herein, vehicle status data may be collected, a vehicle motion profile may be determined, and the vehicle motion profile and other information as described herein may be compared to scene motion profiles associated with candidate media assets. In the exemplary embodiment depicted in FIG. 3, a scene depicting vertical movement such as the giant wave scene of “The Perfect Storm” may be displayed as a media asset by user equipment device 130 to correspond to the downhill motion of the vehicle, as well as the rainy environmental conditions. The scene displayed to correspond with the vehicle motion profile may be inserted into or otherwise combined with other media assets, as described herein.

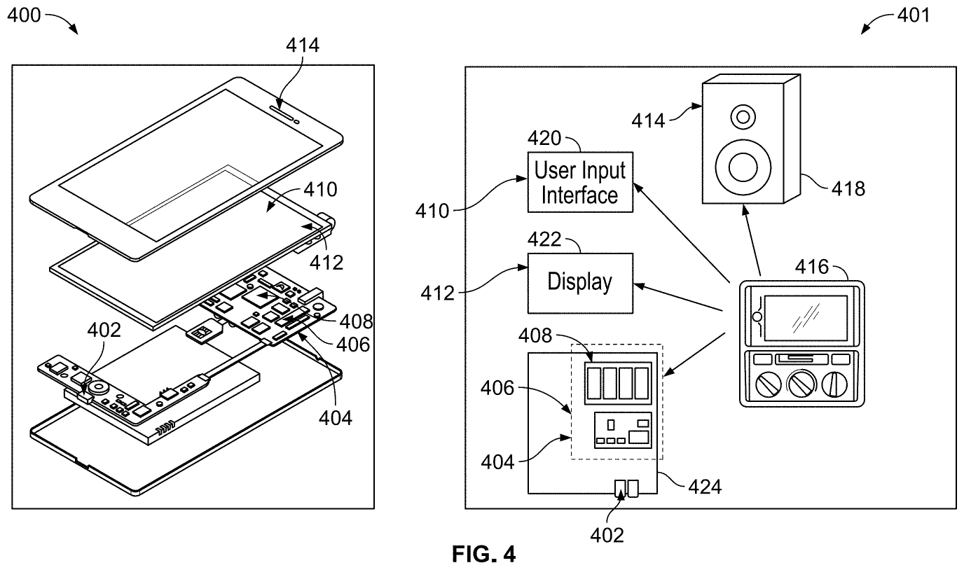

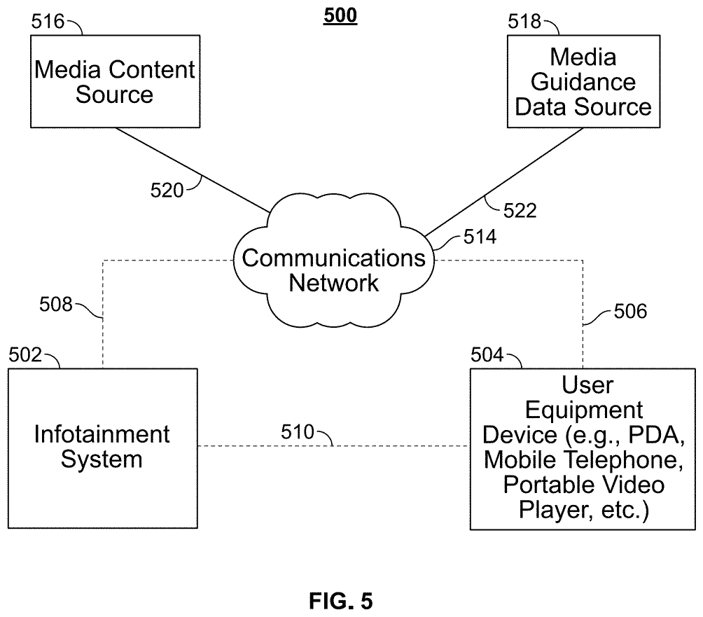

FIGS. 4-5 depict exemplary devices, systems, servers, and related hardware for creating, distributing, analyzing, combining, and displaying media assets and content in accordance with the present disclosure. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory, including, but not limited to, volatile and non-volatile computer memory or storage devices such as a hard disk, floppy disk, USB drive, DVD, CD, media cards, register memory, processor caches, Random Access Memory (“RAM”), etc.

An exemplary user equipment device may include suitable devices for accessing the content described above, including computing devices, screens and other user interface elements. For example, players and smart devices may be components of a vehicle and may be portable devices that are used in a vehicle, and can include computers, dedicated portable media players, infotainment systems, AR headsets, VR headsets, smart phones, and tablets, as well as other display equipment, computing equipment, or wireless devices, and/or combinations of the same. In some embodiments, the user equipment device may implement AR or VR capabilities, and may include a variety of inputs based on user motion (e.g., head motion, hand motion, eye motion, other suitable user motions, and combinations thereof) and additional outputs such as haptic outputs. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, a user interface in accordance with the present disclosure may be available on these devices, as well. The user interface may be for content available only through a vehicle infotainment system, for content available only through one or more of other types of user equipment devices, or for content available both through a vehicle infotainment system and one or more of the other types of user equipment devices. The user interfaces described herein may be provided as on-line applications (i.e., provided on a web-site), or as stand-alone applications or clients on user equipment devices. Various devices and platforms that may implement the present disclosure are described in more detail below.

The devices and systems described herein may allow a user to provide user profile information or may automatically compile user profile information. An application may, for example, monitor the content the user accesses and/or other interactions the user may have with the system and media assets provided through the system. Additionally, the application may obtain all or part of other user profiles that are related to a particular user (e.g., from other web sites on the Internet the user accesses, such as www.Tivo.com, from other applications the user accesses, from other interactive applications the user accesses, from another user equipment device of the user, etc.), and/or obtain information about the user from other sources that the application may access. As a result, a user can be provided with a unified experience across the user's different user equipment devices. Additional personalized application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Users may access content and applications from one or more of their user equipment devices. FIG. 4 shows generalized embodiments of illustrative user equipment device 400 and illustrative user equipment system 401. For example, user equipment device 400 can be a smartphone device having AR/VR capabilities, or a standalone AR/VR device. In another example, user equipment system 401 can be an AR/VR device that is in communication with vehicle systems, as described herein. In another example, user equipment system 401 may be in-vehicle infotainment system and/or vehicle control system. In an embodiment, user equipment system 401 may comprise a vehicle infotainment system 416. Vehicle infotainment system 416 may be communicatively connected to or may include speaker 418 and display 422. In some embodiments, display 422 may be a touch screen display or a computer display. In some embodiments, vehicle infotainment system 416 may be communicatively connected to user interface input 420. In some embodiments, user interface input 420 may include voice and physical user interfaces that allow a user to interact with the infotainment system. Vehicle infotainment system 416 may include circuit board 424. In some embodiments, circuit board 424 may include processing circuitry, control circuitry, and storage (e.g., RAM, ROM, hard disk, removable disk, etc.). In some embodiments, circuit board 424 may include an input/output path. Additional implementations of user equipment devices are discussed below in connection with FIG. 5. Each one of user equipment device 400 and user equipment system 401 may receive content and data via input/output (hereinafter “I/O”) path 402. I/O path 402 may provide content (e.g., broadcast programming, on-demand programming, Internet content, content available over a local area network (LAN) or wide area network (WAN), and/or other content) and data to control circuitry 404, which includes processing circuitry 406 and storage 408. Control circuitry 404 may be used to send and receive commands, requests, and other suitable data using I/O path 402. I/O path 402 may connect control circuitry 404 (and specifically processing circuitry 406) to one or more communications paths (described below). I/O functions may be provided by one or more of these communications paths, but are shown as a single path in FIG. 4 to avoid overcomplicating the drawing.

Control circuitry 404 may be based on any suitable processing circuitry, such as processing circuitry 406. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 404 executes instructions for an application stored in memory (i.e., storage 408). Specifically, control circuitry 404 may be instructed by applications to perform the functions discussed above and below. For example, applications may provide instructions to control circuitry 404 to generate displays. In some implementations, any action performed by control circuitry 404 may be based on instructions received from the applications.

In client/server-based embodiments, control circuitry 404 may include communications circuitry suitable for communicating with an application server or other networks or servers. The instructions for carrying out the above-mentioned functionality may be stored on the application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 5). In addition, communications circuitry may include circuitry that enables peer-to-peer communication of user equipment devices, or communication of user equipment devices in locations remote from each other (described in more detail below).

Memory may be an electronic storage device provided as storage 408 that is part of control circuitry 404. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 408 may be used to store various types of content described herein as well as data described above. Nonvolatile memory may also be used (e.g., to launch a boot-up routine and other instructions). Cloud-based storage, described in relation to FIG. 5, may be used to supplement storage 408 or instead of storage 408.

Control circuitry 404 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 404 may also include scaler circuitry for upconverting and downconverting content into the preferred output format of each one of user equipment device 400 and user equipment system 401. Circuitry 404 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 408 is provided as a separate device from each one of user equipment device 400 and user equipment system 401, the tuning and encoding circuitry (including multiple tuners) may be associated with storage 408.

A user may send instructions to control circuitry 404 using user input interface 410. User input interface 410 may be any suitable user interface, such as a remote control, mouse, trackball, keypad, keyboard, touch screen, touchpad, stylus input, joystick, voice recognition interface, or other user input interfaces. Display 412 may be provided as a stand-alone device or integrated with other elements of each one of user equipment device 400 and user equipment system 401. For example, display 412 may be a touchscreen or touch-sensitive display. In such circumstances, user input interface 410 may be integrated with or combined with display 412. Display 412 may be any suitable display for displaying content as described herein, such as a screen or display of a computer, dedicated portable media player, infotainment system, AR headset, VR headset, smart phone, or tablet. In some embodiments, display 412 may be HDTV-capable. In some embodiments, display 412 may be a 3D display, and the interactive application and any suitable content may be displayed in 3D. A video card or graphics card may generate the output to the display 412. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 404. The video card may be integrated with the control circuitry 404. Speakers 414 may be provided as integrated with other elements of each one of user equipment device 400 and user equipment system 401 or may be stand-alone units. The audio component of videos and other content displayed on display 412 may be played through speakers 414. In some embodiments, the audio may be distributed to a receiver (not shown), which processes and outputs the audio via speakers 414.

Applications may be implemented using any suitable architecture. For example, they may be stand-alone applications wholly implemented on each one of user equipment device 400 and user equipment system 401. In such an approach, instructions of the applications are stored locally (e.g., in storage 408), and data for use by the application is downloaded on a periodic basis (e.g., from an out-of-band feed, from an Internet resource, or using another suitable approach). Control circuitry 404 may retrieve instructions of the application from storage 408 and process the instructions to generate any of the displays discussed herein. Based on the processed instructions, control circuitry 404 may determine what action to perform when input is received from input interface 410. For example, movement of a cursor on a display up/down may be indicated by the processed instructions when input interface 410 indicates that an up/down button was selected.

In some embodiments, the application is a client-server based application. Data for use by a thick or thin client implemented on each one of user equipment device 400 and user equipment system 401 is retrieved on-demand by issuing requests to a server remote to each one of the user equipment device 400 and the user equipment system 401. In one example of a client/server-based application, control circuitry 404 runs a web browser that interprets web pages provided by a remote server. For example, the remote server may store the instructions for the application in a storage device. The remote server may process the stored instructions using circuitry (e.g., control circuitry 404) and generate the displays discussed above and below. The client device may receive the displays generated by the remote server and may display the content of the displays locally on each one of equipment device 400 and equipment system 401. This way, the processing of the instructions is performed remotely by the server while the resulting displays are provided locally on each one of equipment device 400 and equipment system 401. Each one of equipment device 400 and equipment system 401 may receive inputs from the user via input interface 410 and transmit those inputs to the remote server for processing and generating the corresponding displays. For example, each one of equipment device 400 and equipment system 401 may transmit a communication to the remote server indicating that an up/down button was selected via input interface 410. The remote server may process instructions in accordance with that input and generate a display of the application corresponding to the input (e.g., a display that moves a cursor up/down). The generated display is then transmitted to each one of equipment device 400 and equipment system 401 for presentation to the user.

In some embodiments, the application is downloaded and interpreted or otherwise run by an interpreter or virtual machine (run by control circuitry 404). In some embodiments, the application may be encoded in the ETV Binary Interchange Format (EBIF), received by control circuitry 404 as part of a suitable feed, and interpreted by a user agent running on control circuitry 404. For example, the application may be an EBIF application. In some embodiments, the application may be defined by a series of JAVA-based files that are received and run by a local virtual machine or other suitable middleware executed by control circuitry 404. In some of such embodiments (e.g., those employing MPEG-2 or other digital media encoding schemes), the application may be, for example, encoded and transmitted in an MPEG-2 object carousel with the MPEG audio and video packets of a program.

Each one of user equipment device 400 and user equipment system 401 of FIG. 4 can be implemented in system 500 of FIG. 5 as vehicle infotainment equipment 502, user device 504, or any other type of user equipment suitable for accessing content. For simplicity, these devices may be referred to herein collectively as user equipment or user equipment devices, and may be substantially similar to user equipment devices described above. User equipment devices, on which an application may be implemented, may function as standalone devices or may be part of a network of devices. Various network configurations of devices may be implemented and are discussed in more detail below.

A user equipment device utilizing at least some of the system features described above in connection with FIG. 4 may not be classified solely as vehicle infotainment equipment 502 or user device 504. For example, vehicle infotainment equipment 502 may, like some user devices 504, be Internet-enabled allowing for access to Internet content, while user device 504 may, like some user-infotainment equipment 502, have capability of assessing vehicle, environmental, and locale conditions. Applications may have the same layout on various different types of user equipment or may be tailored to the display capabilities of the user equipment. For example, on user device 504, applications may be provided as a web site accessed by a web browser.

In system 500, there may be more than one of each type of user equipment device but only one of each is shown in FIG. 5 to avoid overcomplicating the drawing. In addition, each user may utilize more than one type of user equipment device and also more than one of each type of user equipment device.

In some embodiments, a user equipment device (e.g., vehicle infotainment equipment 502 and/or user device 504) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same vehicle as the first device, a different vehicle from the first device but in the same household, or in a different vehicle from a different household. In some embodiments, media assets such as AR/VR content may be provided on a second screen device while other content such as vehicle navigation information is displayed on a first user equipment device such as a vehicle infotainment system.

The user may also set various settings to maintain consistent application settings across in-home devices and remote devices (e.g., in vehicles). Settings include those described herein, as well as channel and program favorites, programming preferences that the application utilizes to make programming recommendations, display preferences, and other desirable guidance settings such as settings related to selection of media assets that relate to vehicle motion profiles. For example, a user may maintain a variety of settings related to vehicle motion profiles, such as selection of certain content (e.g., by type, provider, content, etc.) to be analyzed for comparison to vehicle motion profiles, preferences related to locales and environmental conditions, and preferences for the insertion of scenes and creation of composite media assets. Changes made on one user equipment device can change the guidance experience on another user equipment device, regardless of whether they are the same or a different type of user equipment device. In addition, the changes made may be based on settings input by a user, as well as user activity monitored by applications.

The user equipment devices may be coupled to communications network 514. Namely, vehicle infotainment equipment 502 and user device 504 are coupled to communications network 514 via communications paths 508 and 506, respectively. Further, vehicle infotainment equipment 502 and user device 5-4 may also have a direct communication path with each other, such as through communication path 510.

Communications network 514 may be one or more networks including the Internet, a mobile phone network, mobile voice or data network (e.g., a 4G or LTE network), cable network, public switched telephone network, or other types of communications network or combinations of communications networks. Paths 506 and 508 may separately or together include one or more communications paths, such as a satellite path, a fiber-optic path, a cable path, a path that supports Internet communications (e.g., cellular, WiFi, etc.), free-space connections (e.g., for broadcast or other wireless signals), or any other suitable wireless communications path or combination of such paths. Path 510 may be a suitable wired or wireless connection such USB, USB-C, Lightning, WiFi, Bluetooth, NFC, mesh, or any other suitable communication link that provides for communications between infotainment system 502 and user device 504 without communicating through communications network 514, although in some embodiments infotainment system 502 and user device 504 may communicate view communication network 514 for some or all communications between those two devices.

System 500 includes content source 516 and data source 518 coupled to communications network 514 via communication paths 520 and 522, respectively. Paths 520 and 522 may include any of the communication paths described above in connection with paths 506, 508, and 510. Communications with the content source 516 and data source 518 may be exchanged over one or more communications paths, but are shown as a single path in FIG. 5 to avoid overcomplicating the drawing. In addition, there may be more than one of each of content source 516 and data source 518, but only one of each is shown in FIG. 5 to avoid overcomplicating the drawing. (The different types of each of these sources are discussed below.) If desired, content source 516 and data source 518 may be integrated as one source device. Although communications between sources 516 and 518 with user equipment devices 502 and 504 are shown as through communications network 514, in some embodiments, sources 516 and 518 may communicate directly with user equipment devices 502 and 504 via communication paths (not shown) such as those described above in connection with paths 506, 508, and 510.

Content source 516 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 516 may be the originator of content (e.g., a television broadcaster, a Webcast provider, etc.) or may not be the originator of content (e.g., an on-demand content provider, an Internet provider of content of broadcast programs for downloading, etc.). Content source 516 may include cable sources, satellite providers, on-demand providers, Internet providers, over-the-top content providers, or other providers of content. Content source 516 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Data source 518 may provide information such as scene motion profiles, user-related profiles and settings, and other related information for the comparison, selection, and display of scenes that correspond to vehicle motion profiles as described herein. In some embodiments, the vehicle motion profiles and other information (e.g., environmental information and locale information) may be received from and provided to the user equipment through wireless communications as described herein.

In some embodiments, selected scenes or information that may be used to select scenes (e.g., scene motion profiles) from data source 518 may be provided to a user's equipment using a client-server approach. For example, a user equipment device may pull data from a server, or a server may push data to a user equipment device. In some embodiments, an application client residing on the user's equipment may initiate sessions with data source 518 to obtain motion-related data when needed, e.g., when a user initiates a trip in a vehicle and when vehicle motion profiles or other related information changes during a trip. Communication between data source 518 and the user equipment may be provided with any suitable frequency (e.g., continuously, daily, a user-specified period of time, a system-specified period of time, in response to a request from user equipment, etc.).

In some embodiments, data received by the data source 518 may include vehicle data that may be used as training data. For example, the vehicle data may include current and/or historical vehicle status data and vehicle motion profile information related to particular times, locations, vehicles, drivers, or any suitable combination thereof. In some embodiments, the user activity information may include data from other devices, such as multiple vehicles traveling under similar conditions.

Applications may be, for example, stand-alone applications implemented on user equipment devices. For example, the application may be implemented as software or a set of executable instructions which may be stored in storage 408, and executed by control circuitry 404 of each one of a user equipment device 400 and 401. In some embodiments, applications may be client-server applications where only a client application resides on the user equipment device, and a server application resides on a remote server. For example, applications may be implemented partially as a client application on control circuitry 404 of each one of user equipment device 400 and user equipment system 401 and partially on a remote server as a server application (e.g., data source 518) running on control circuitry of the remote server. When executed by control circuitry of the remote server (such as data source 518), the application may instruct the control circuitry to generate the application displays and transmit the generated displays to the user equipment devices. The server application may instruct the control circuitry of the data source 518 to transmit data for storage on the user equipment. The client application may instruct control circuitry of the receiving user equipment to generate the application displays.

Content and/or data delivered to user equipment devices 502 and 504 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide data described above. In addition to content and/or data, providers of OTT content can distribute applications (e.g., web-based applications or cloud-based applications), or the content can be displayed by applications stored on the user equipment device.

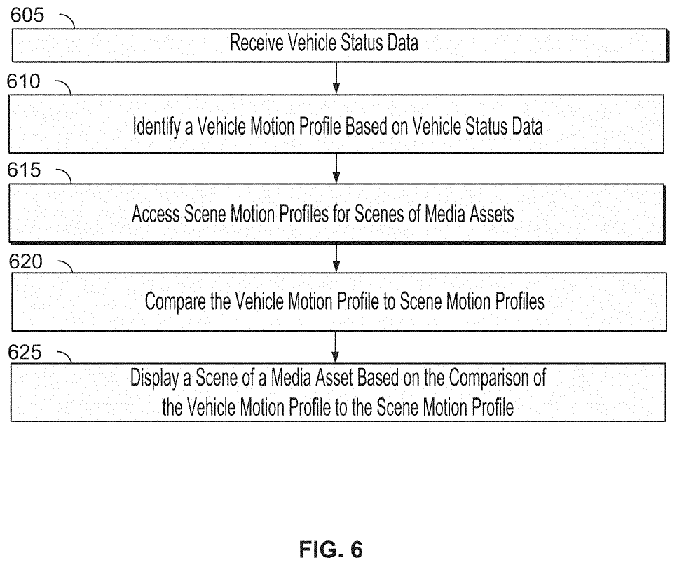

FIG. 6 is a flowchart of a process for providing a scene of a media asset based on vehicle conditions, in accordance with some embodiments of the disclosure. The processes of FIGS. 6-8 may be executed by any of control circuitry (e.g., control circuitry 404) any computing equipment and devices described herein, such as different types of user equipment, content sources, and data sources as described herein. Although particular steps of these methods may be described herein as being performed by particular equipment or devices, it will be understood that the steps of the processes depicted and described in FIGS. 6-8 or aspects of those steps may be performed at different computing equipment and devices and data exchanged over communications networks as described herein.

At step 605, vehicle status data may be received based on information collected from vehicle systems as described herein, and in some embodiments may also be collected based on information received by a user equipment device of a user in the vehicle. The vehicle status data may be raw data, may be calculated from raw data collected from the vehicle, may be determined by comparing multiple types of received data, may be discerned from patterns of data over time, or any suitable combination thereof. The collected vehicle status data may be stored in data structures in a suitable manner, for example, based on time stamps and data types associated with the vehicle status data. In some embodiments, other data may also be collected relating to conditions external to the vehicle such as environmental conditions and locale information. This other data may be used to determine certain vehicle status data (e.g., combining weather conditions and acceleration/deceleration) or, in some embodiments may be used to select among vehicle motion profiles, as described herein.

At step 610, a vehicle motion profile may be identified based on the vehicle status data. The vehicle motion profile may correspond to a type of motion such as turning, rising, falling, accelerating, decelerating, other vehicle motion conditions, and combinations thereof. For example, a vehicle status data relating to a location, upcoming turns in the road, velocity, braking, and acceleration/deceleration may be utilized to identify a vehicle motion profile that includes frequent turning and acceleration/deceleration events.

At step 615, scene motion profiles may be accessed for scenes of media assets. In some embodiments, scene motion profiles may be stored as searchable data structures that are accessible, for example, at the user equipment device. However, it will be understood that some or all scene motion profiles may be stored elsewhere, such as at a media content source or a data source. Although the scene motion profiles and vehicle motion profiles may be stored in any suitable manner, in an exemplary embodiment each of the profiles may include a value associated with each of a plurality of motion types. The values may be normalized to facilitate comparison between vehicle motion profiles and scene motion profiles. In some embodiments, the scene motion profiles available for comparison may be further selected or weighted based on other information such as user preferences, environmental conditions, or locale information.

At step 620, the vehicle motion profile may be compared to the accessed scene motion profiles to select a scene for display with the vehicle motion. In an exemplary embodiment, similarity scores may be calculated based on the respective values for motion types of the vehicle motion profile and the scene motion profiles. The similarity scores may be aggregated to identify and rank scenes based on their overall similarity to the vehicle motion profile. In some embodiments, one or more primary motion types may be identified from the vehicle motion profile, and scenes may be ranked based only upon the primary motion profiles or by giving greater weight to the primary motion types. In some embodiments, in addition to the comparison based on motion profiles, additional information such as user preferences, environmental conditions, locale information, and other similar information may be utilized to provide weighting to particular scenes or motion types, or to select among subsets of scene motion profiles having qualifying similarity values. For example, a subset of potential scenes may be selected based on similarity scores, and selection from among that subset may be based on the additional information. In some embodiments the selection may further be based on a comparison with the media asset being viewed or based on advertising requests such as auction bids.

At step 625, a scene of a media asset may be displayed at the user equipment device based on the comparison of the vehicle motion profile to the scene motion profiles. For example, an insertion point in the scene may be identified during a transition between scenes, locations, motion, actors, objects, or dialogue. The selected scene may then be displayed to the user such that the motion experienced in the vehicle corresponds to the scene, for example, as augmented reality or virtual reality content. In some embodiments, additional outputs such as haptic outputs of the user equipment device may be enabled to further simulate the condition. In additional embodiments, the user may be provided an option of whether to display the scene that corresponds to the vehicle motion profile, for example, as a diversion from the primary media asset being viewed by the user.

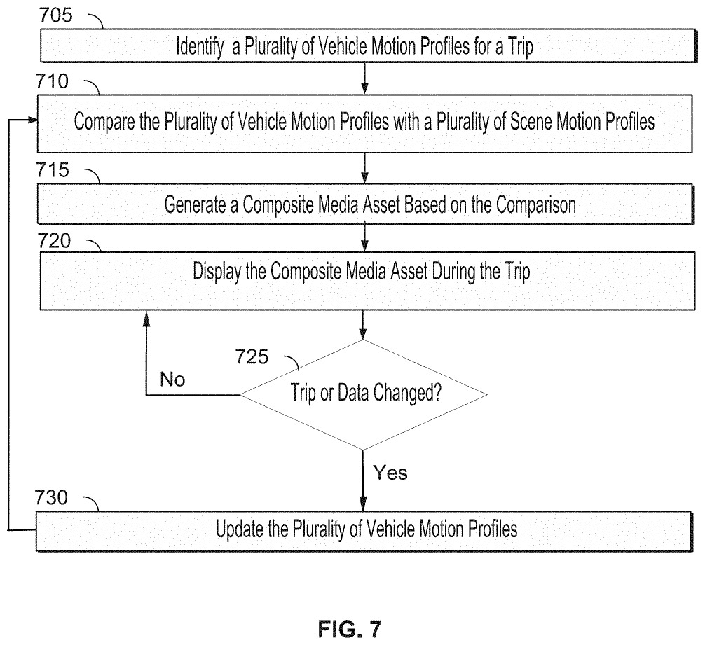

FIG. 7 is a flowchart of a process for creating a composite media asset based on vehicle conditions, in accordance with some embodiments of the disclosure. As described herein, in some embodiments a composite media asset may be created for a user during a particular trip. The composite media asset may be generated to match the time to the destination and may bring together a composite of scenes based on changing vehicle motion data as well as changes to the route or trip. In some embodiments, the composite media asset may be pieced together from different assets that are related, such as by actor, genre, series, storyline, and other related characteristics. In additional embodiments, a user may have a watchlist of multiple shows, and the composite media asset may be created to match scenes from the watchlisted shows to the vehicle motion profile, while maintaining the user's overall progress within each respective media asset. In further embodiments, media assets may be created that provide multiple optional stories that depend at least in part on the vehicle motion profile, for example, by providing multiple optional stories or providing the vehicle motion profile as input for interactive gaming.

At step 705, a plurality of vehicle motion profiles may be identified for a trip. As described herein, information relating to the vehicle systems, other external conditions, and a particular trip may be accessible from a wide variety of sources. This information may be utilized to generate predictions as to vehicle motion profiles that will be experienced during the trip, for example, based on driver tendencies determined from vehicle status data, route data, and traffic data. In some embodiments, the predictions may be associated with certainty levels based on the quality of the predictive information that is provided. Vehicle motion profiles and candidates for likely vehicle motion profiles may be identified based on this information and as described herein for the duration of a trip, for a predictive window (e.g., five minutes into the future), based on certainty levels, or in other suitable manners, based on the vehicle status data and other available information (e.g., user preferences, environmental conditions, and locale information).

At step 710, the plurality of vehicle motion profiles from step 705 may be compared with a plurality of scene motion profiles for the portion of the trip. In some embodiments, certainty scores may be used to select multiple candidate scenes for any particular subpart of the portion of the trip. In this manner, scenes may be preloaded based on likely changes to a route or changes in the vehicle status data. As described herein, similarity scores may be determined and results may be filtered further, based on other available information such as user preferences, environmental conditions, and locale information.

At step 715, a composite media asset may be generated based on the comparison of step 710. As described herein, a variety of composite media asset types may be available for creation in accordance with the present disclosure. Based on the type of composite media asset and the comparisons of step 710, a composite media asset may be prepared for display to the user, e.g., by preloading content to the user equipment device in anticipation of the predicted vehicle motion profile and other relevant conditions. The generation of the composite media asset may be based on a variety of factors alone or in combination as described herein, such as a number of equivalent or similar objects and characters appearing in scenes, a timing sequence within a media asset of scenes, similar motion characteristics for a scene, colors or color ranges for scenes, similarities in environment conditions between scenes, time of day for scenes, depicted eras (e.g., prehistory, future, medieval, etc.), suburb, forest, desert, mountains, ocean, etc.), and other content such as music or dialogue. In some embodiments, additional content and data such as filters and effects to manage transitions between scenes, interactive content, user notifications, and other suitable information may be associated with the composite media asset.

At step 720, the composite media asset may be played to the user as described herein. As the user progresses through the trip, the scenes of the composite media asset may be coordinated for sequential display, and, in some embodiments, transitions and interactive user options may be provided to the user between scenes. In this manner, the user may be provided with a media asset that matches the vehicle motion profile throughout the user's trip.

At step 725, the system may continue to monitor the vehicle systems and other available information to determine whether changes have occurred in the vehicle motion data, the current trip, or in other relevant information such as environmental conditions or consideration of user preferences of an additional user for the media asset. If changes have occurred that may require a change in the composite media asset, processing may continue to step 730 to update the plurality of vehicle motion profiles as described herein and repeat the processing of steps 710, 715, and 720. Otherwise, processing may return to step 720 and the current composite media asset may continue to be displayed.

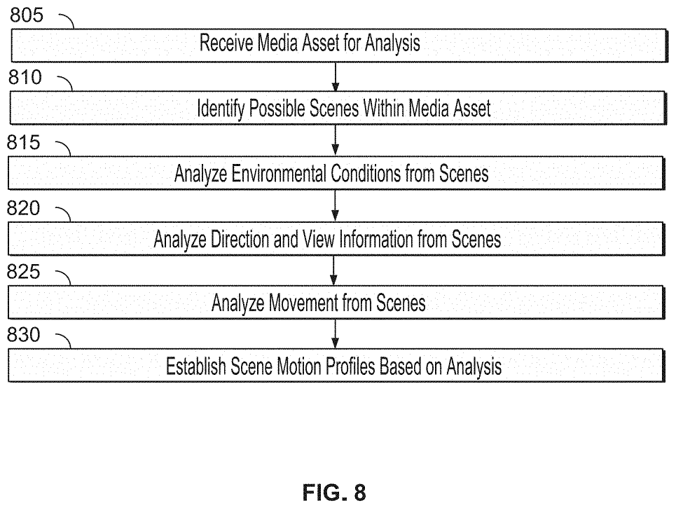

FIG. 8 is a flowchart of a process for analyzing media assets for motion profiles in accordance with some embodiments of the present disclosure. As described herein, vehicle motion profiles may be compared to scene motion profiles to identify an appropriate scene for display at a user equipment device. FIG. 8 provides exemplary steps for identifying scenes and scene motion profiles for comparison to vehicle motion profiles.

At step 805, one or more media assets may be received. Media assets may be received and processed individually, or, in some embodiments, a set of media assets may be identified for analysis based on criteria such as user preferences, for example, for potential inclusion in a composite media asset.

At step 810, possible scenes may be identified for the received media asset. The media asset may be analyzed based on any suitable units or portions of the media asset, such as frame-by-frame, for a selected number of frames, based on an amount of data for analysis, based on time, or any suitable combination thereof. Each analyzed portion of the media asset may be analyzed for a variety of characteristics, such as type of motion depicted in the portion (e.g., turning, jerking, vibrating, accelerating, decelerating, rising, falling, etc.), the frame of reference and locale depicted in the analyzed portion (e.g., in the sky, in space, on land, on water, under water, in a forest, in mountains, in a desert, in a city, in a suburb, etc.), environmental conditions depicted in the portion of the media asset (e.g., rain, snow, heat, cold, humidity, fog, cloud cover, wind, day, night, etc.), and for objects and persons depicted in the media asset. Scenes for purposes of comparison may be identified based on multiple contiguous portions of the media asset maintaining consistencies in some, all, or a large proportion of these characteristics. In some embodiments, certain characteristics such as type of motion may receive a higher priority in determining whether contiguous portions of the media asset should be considered as a single scene.

At step 815, environmental conditions may be analyzed for each of the scenes of the media asset or media assets. The content of the scene of the media asset (e.g., video, audio, or both) and related information (e.g., metadata) may be analyzed to identify environmental conditions such as rain, snow, heat, cold, fog, cloud cover, wind, humidity, day, and night. The environmental characteristics may be stored, and, in some embodiments, may be scored based on prominence or intensity (e.g., heavy rainfall). The resulting data relating to environmental conditions may be associated with the scene and stored for future comparison with information relating to a trip for a vehicle.

At step 820, direction and view information may be analyzed for each of the scenes of the media asset or media assets, as described herein. Examples of direction and view information include situations such as flying in the sky or space in a straight path with a view of any one of the sides, flying in the sky or space in a circular path with a view of any one of the sides, moving on land or on water in a straight path with a view of any one of the sides, moving on land or on water in a circular path with a view of any one of the sides, moving inside water in a straight path with a view of any one of the sides, moving inside water in a circular path with a view of any one of the sides, being suspended or hanging from an altitude, as well as other suitable combinations of directions and views. The scene and view characteristics may be stored, and, in some embodiments, may be scored based on prominence or intensity (e.g., a tight circular path). The resulting data relating to direction and view may be associated with the scene and stored for future comparison with information relating to a trip for a vehicle.

At step 825, movement may be analyzed for each of the scenes of the media asset or media assets. Characters and objects depicted in a scene may be analyzed to identify motions such as turning, jerking, vibrating, accelerating, decelerating, rising, and falling. In instances where multiple objects appear, different movements may be associated with different characters or objects, or, in some embodiments, a blended movement analysis may be determined based on the prominence of different types of motion within the overall scene (e.g., based on the aggregate amount and intensity of different types of motion). The movement characteristics may be stored, and, in some embodiments, may be scored based on prominence or intensity (e.g., abrupt and sustained acceleration). The resulting data relating to movement may be associated with the scene and stored for future comparison with information relating to a trip for a vehicle.

At step 830, scene motion profiles may be established for the scenes based on the analysis of steps 805-825. The scene may be made independently accessible and the results of the analysis may be associated with the scene, for example, as metadata for the scene.

It is contemplated that the steps or descriptions of FIGS. 6-8 may be used with any other embodiment of this disclosure. In addition, the steps and descriptions described in relation to FIGS. 6-8 may be done in alternative orders or in parallel to further the purposes of this disclosure. Any of these steps may also be skipped or omitted from the process. Furthermore, it should be noted that any of the devices or equipment discussed in relation to FIGS. 4-5 could be used to perform one or more of the steps in FIGS. 6-8.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method for presenting a scene of a media asset for display in a vehicle, comprising:
receiving vehicle status data, wherein the vehicle status data is based on information collected from one or more systems of the vehicle;
identifying, from the vehicle status data, a vehicle motion profile for the vehicle;
accessing, for each of a plurality of scenes of one or more media assets, a respective scene motion profile, wherein each scene motion profile is associated with one or more motions depicted in an associated scene of the plurality of scenes;
comparing the vehicle motion profile with the respective scene motion profiles;
identifying a first scene of the plurality of scenes based on the comparing; and
providing the first scene for display at a device associated with the vehicle.

2. The method of claim 1, wherein comparing the vehicle motion profile with the respective scene motion profiles comprises determining a similarity score between the vehicle motion profile and each of the respective scene motion profiles, and wherein identifying the first scene comprises selecting the first scene based on the similarity scores.

3. The method of claim 2, further comprising accessing a user profile, wherein identifying the first scene comprises:
identifying a subset of the similarity scores that exceed a similarity value, wherein a subset of the plurality of scenes is associated with the subset of similarity scores; and
selecting the first scene from the subset of scenes based on the user profile.

4. The method of claim 3, wherein the user profile comprises preferred genres, preferred media assets, or preferred actors.

5. The method of claim 1, wherein the vehicle status data comprises velocity, acceleration, altitude, direction, or angular velocity, and wherein the vehicle motion profile comprises turning, rising, falling, accelerating, or decelerating.

6. The method of claim 1, further comprising determining environmental conditions based on the information collected from one or more systems of the vehicle, wherein the first scene is further selected based on the environmental conditions.

7. The method of claim 1, wherein identifying the motion profile comprises comparing the vehicle status data to location data of the vehicle, further comprising:
identifying a plurality of additional vehicle motion profiles based on the vehicle status data and the location of the vehicle, wherein the additional vehicle motion profiles are each associated with predicted future travel for the vehicle;
comparing each of the additional vehicle motion profiles with the respective scene motion profiles;
identifying, for each of the additional vehicle motion profiles, an additional scene of the plurality of scenes based on the comparing of the additional vehicle motion profiles; and
providing the additional scenes for display at the device.

8. The method of claim 7, further comprising:
determining, based on one or more of the location data and the vehicle status data, that the predicted future travel of the vehicle has changed; and
updating the additional vehicle motion profiles and the additional scenes based on the changed future travel.

9. The method of claim 1, wherein providing the first scene for display at the device comprises:
identifying an insertion point within a primary media asset being displayed at the device; and
inserting the first scene for display at the insertion point.

10. The method of claim 1, wherein the first scene is provided for display as augmented reality content or virtual reality content.

11. A system for presenting a scene of a media asset for display in a vehicle, comprising:
control circuitry configured to:
receive vehicle status data, wherein the vehicle status data is based on information collected from one or more systems of the vehicle;
identify, from the vehicle status data, a vehicle motion profile for the vehicle;
access, for each of a plurality of scenes of one or more media assets, a respective scene motion profile, wherein each scene motion profile is associated with one or more motions depicted in an associated scene of the plurality of scenes;
compare the vehicle motion profile with the respective scene motion profiles;
identify a first scene of the plurality of scenes based on the comparison; and
provide the first scene for display at a device associated with the vehicle.

12. The system of claim 11, wherein the comparison of the vehicle motion profile with the respective scene motion profiles comprises a determination of a similarity score between the vehicle motion profile and each of the respective scene motion profiles, and wherein the identification of the first scene comprises a selection of the first scene based on the similarity scores.

13. The system of claim 12, wherein the control circuitry is further configured to access a user profile, and wherein the control circuitry, to identify the first scene, is configured to:
identify a subset of the similarity scores that exceed a similarity value, wherein a subset of the plurality of scenes is associated with the subset of similarity scores; and
select the first scene from the subset of scenes based on the user profile.

14. The system of claim 13, wherein the user profile comprises preferred genres, preferred media assets, or preferred actors.

15. The system of claim 11, wherein the vehicle status data comprises velocity, acceleration, altitude, direction, or angular velocity, and wherein the vehicle motion profile comprises turning, rising, falling, accelerating, or decelerating.

16. The system of claim 11, wherein the control circuitry is further configured to determine environmental conditions based on the information collected from one or more systems of the vehicle, wherein the first scene is further selected based on the environmental conditions.

17. The system of claim 11, wherein the identification of the motion profile comprises comparing the vehicle status data to location data of the vehicle, and wherein the control circuitry is further configured to:
identify a plurality of additional vehicle motion profiles based on the vehicle status data and the location of the vehicle, wherein the additional vehicle motion profiles are each associated with a predicted future travel for the vehicle;
compare each of the additional vehicle motion profiles with the respective scene motion profiles;
identify, for each of the additional vehicle motion profiles, an additional scene of the plurality of scenes based on the comparison of the additional vehicle motion profiles; and
provide the additional scenes for display at the device.

18. The system of claim 17, wherein the control circuitry is further configured to:
determine, based on one or more of the location data and the vehicle status data, that the predicted future travel of the vehicle has changed; and
update the additional vehicle motion profiles and the additional scenes based on the changed future travel.

19. The system of claim 11, wherein, to provide the first scene for display at the device, the control circuitry is configured to:
identify an insertion point within a primary media asset being displayed at the device; and
insert the first scene for display at the insertion point.

20. The system of claim 11, wherein the first scene is provided for display as augmented reality content or virtual reality content.
